(19) United States
(12) Patent Application Publication
(10) Pub. No.: US 2023/0128037 A1
(43) Pub. Date: Apr. 27, 2023

(54) TRANSPARENT KEYCAP MANUFACTURING METHOD AND TRANSPARENT KEYCAP THEREOF

(71) Applicant: DARFON ELECTRONICS CORP., Taoyuan City (TW)

(72) Inventors: Shih-Kai Chen, Taoyuan City (TW); Tsai-Jung Hu, Taoyuan City (TW)

(73) Assignee: DARFON ELECTRONICS CORP., Taoyuan City (TW)

(21) Appl. No.: 17/732,550

(22) Filed: Apr. 29, 2022

Related U.S. Application Data
(60) Provisional application No. 63/270,068, filed on Oct. 21, 2021.

(30) Foreign Application Priority Data
Jan. 10, 2022 (TW) 111100951

(51) Int. Cl. B44C 1/22; H01H 13/88

(52) U.S. Cl. CPC B44C 1/228; H01H 13/88

(57) ABSTRACT

A transparent keycap manufacturing method includes adhering an opaque base to a fixing film, performing a laser engraving process or an etching process on a bottom surface of the opaque base to generate a continuous hollow pattern region and a pattern component surrounded by the continuous hollow pattern region, coating transparent glue on the bottom surface of the opaque base to fill the continuous hollow pattern region with the transparent glue, adhering a transparent base to the bottom surface of the opaque base, and removing the fixing film from the opaque base.

### CROSS REFERENCE TO RELATED APPLICATIONS

This application claims the benefit of U.S. Provisional Application No. 63/270,068, filed on Oct. 21, 2021. The content of the application is incorporated herein by reference.

### BACKGROUND OF THE INVENTION

### 1. Field of the Invention

The present invention relates to a transparent keycap manufacturing method and a transparent keycap thereof, and more specifically, to a transparent keycap manufacturing method involving fixing a pattern component in a continuous hollow pattern region via a fixing film and a transparent keycap thereof.

### 2. Description of the Prior Art

A keyboard, which is the most common input device, could be found in variety of electronic apparatuses for users to input characters, symbols, numerals and so on. Furthermore, from consumer electronic products to industrial machine tools, they are all equipped with a keyboard for performing input operations.

In practical application, if it is desired to make a keycap on a keyboard have a hard material luster and provide a pattern lighting effect, a conventional process is to adopt metal or ceramic material to manufacture the keycap and then utilize a laser engraving process or an etching process to form a hollow pattern (e.g., character or symbol) on the keycap. Accordingly, via the design that light generated by a backlight device disposed under the keycap is emitted from the hollow pattern, the pattern lighting effect can be achieved. However, the aforesaid design may cause the problem that non-transparent regions on the keycap needs to be connected to each other and cannot be completely cut off by the hollow pattern, so as to greatly limit the pattern design and manufacturing quality of the transparent keycap.

### SUMMARY OF THE INVENTION

The present invention provides a transparent keycap manufacturing method. The transparent keycap manufacturing method includes providing an opaque base and a fixing film, adhering the opaque base to the fixing film, performing a laser engraving process or an etching process on a bottom surface of the opaque base to generate a continuous hollow pattern region and a pattern component surrounded by the continuous hollow pattern region, coating a transparent glue on the bottom surface of the opaque base to fill the continuous hollow pattern region with the transparent glue, providing a transparent base having a plurality of connection components for connecting to a scissor lifting mechanism, adhering a transparent base to the bottom surface of the opaque base, and removing the fixing film from the opaque base.

The present invention further provides a transparent keycap. The transparent keycap includes an opaque base, a transparent glue, and a transparent base. The opaque base has a fixing film attached thereon. A continuous hollow pattern region and a pattern component are formed on the opaque base by performing a laser engraving process or an etching process on a bottom surface of the opaque base. The pattern component is surrounded by the continuous hollow pattern region. The transparent glue is coated on the bottom surface of the opaque base to fill the continuous hollow pattern region. The transparent base is attached to the bottom surface of the opaque base. The transparent base has a plurality of connection components for connecting to a scissor lifting mechanism. The pattern component is fixed in the continuous hollow pattern region via the transparent glue after the fixing film is removed from the opaque base.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a transparent keycap manufacturing method according to an embodiment of the present invention.

FIG. 2 is a process diagram according to FIG. 1.

FIG. 3 is a cross-sectional diagram of a transparent keycap according to an embodiment of the present invention.

FIG. 4 is a process diagram of a transparent keycap manufacturing method according to another embodiment of the present invention.

FIG. 5 is a diagram of a keyboard according to an embodiment of the present invention.

FIG. 6 is a cross-sectional diagram of a keyswitch in FIG. 5 along a cross-sectional line X-X.

### DETAILED DESCRIPTION

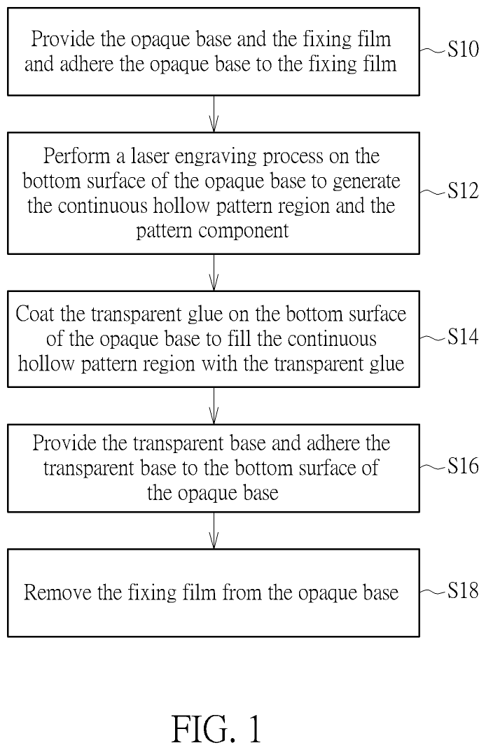

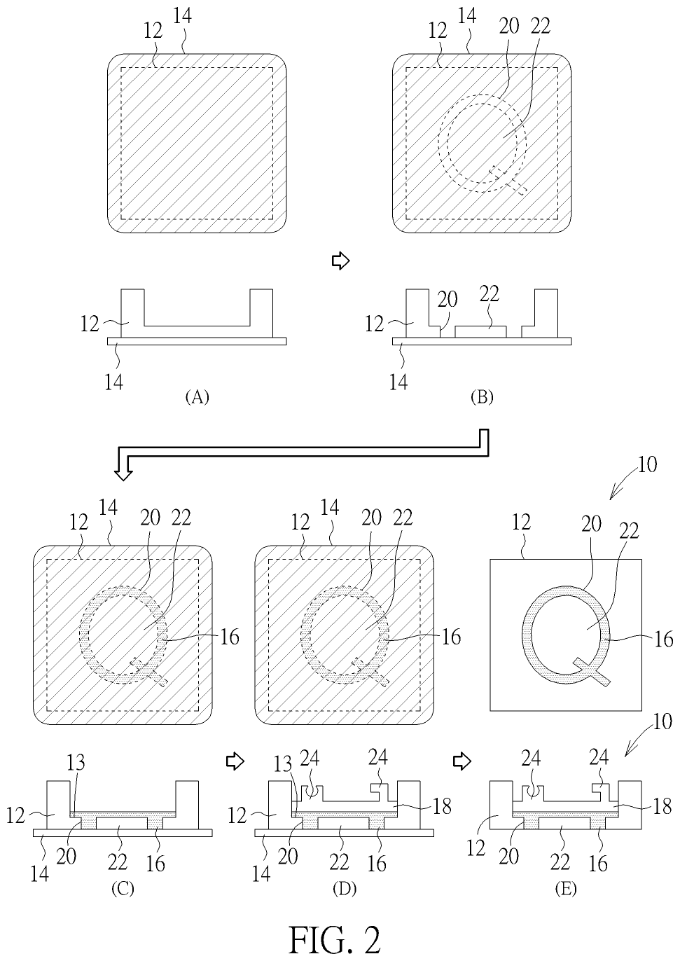

Please refer to FIG. 1 and FIG. 2. FIG. 1 is a flowchart of a transparent keycap manufacturing method according to an embodiment of the present invention. FIG. 2 is a process diagram according to FIG. 1. For clear description of this embodiment, FIGS. 2(A)˜2(E) are presented by cross-sectional diagrams with top views.

First, Step S10 is performed to provide an opaque base 12 and a fixing film 14 and adhere the opaque base 12 to the fixing film 14 as shown in FIG. 2(A). In this embodiment, a transparent keycap 10 includes the opaque base 12, a transparent glue 16, and a transparent base 18. The opaque base 12 could be preferably made of metal material (but not limited thereto, meaning that the opaque base 12 could be made of other hard material (e.g., ceramic material) in another embodiment) to make the transparent keycap 10 have a hard material luster. The fixing film 14 could be preferably a UV release film or a separate film (but not limited thereto) for the subsequent film removing process.

Subsequently, Step S12 involves performing a laser engraving process on a bottom surface 13 of the opaque base 12 (but not limited thereto, meaning that the present invention could adopt other hollow pattern forming process in another embodiment, such as an etching process) for forming a continuous hollow pattern region 20 and a pattern component 22. The pattern component 22 is surrounded by the continuous hollow pattern region 20. At this time, as shown in FIG. 2(B), even if the pattern component 22 has been completely cut off by the continuous hollow pattern region 20 to be separate from the opaque base 12, the pattern component 22 can be still fixed in the continuous hollow pattern region 20 via the fixing film 14.

Step S14 is then performed to coat the transparent glue 16 on the bottom surface 13 of the opaque base 12 for the subsequent base fixing process. During this process, the transparent glue 16 can fill the continuous hollow pattern region 20 as shown in FIG. 2(C).

Step S16 is then performed to provide the transparent base 18 (preferably made of transparent plastic material, but not limited thereto) and then adhere the transparent base 18 to the bottom surface 13 of the opaque base 12. As shown in FIG. 2(D), the transparent base 18 could have a plurality of connection components 24 to be connected to a scissor lifting mechanism (but not limited thereto, meaning that the present invention could adopt other lifting mechanism applied to a keyboard, such as a butterfly lifting mechanism or a magnetic lifting mechanism) for a user to press.

Finally, Step S18 is performed to remove the fixing film 14 from the opaque base 12 as shown in FIG. 2(E). At the same time, the pattern component 22 can be fixed in the continuous hollow pattern region 20 via the transparent glue 16 after the fixing film 14 is removed from the opaque base 12. As for the related description for the film removing method (e.g., a UV releasing method or a film tearing method), it is commonly seen in the prior art and omitted herein.

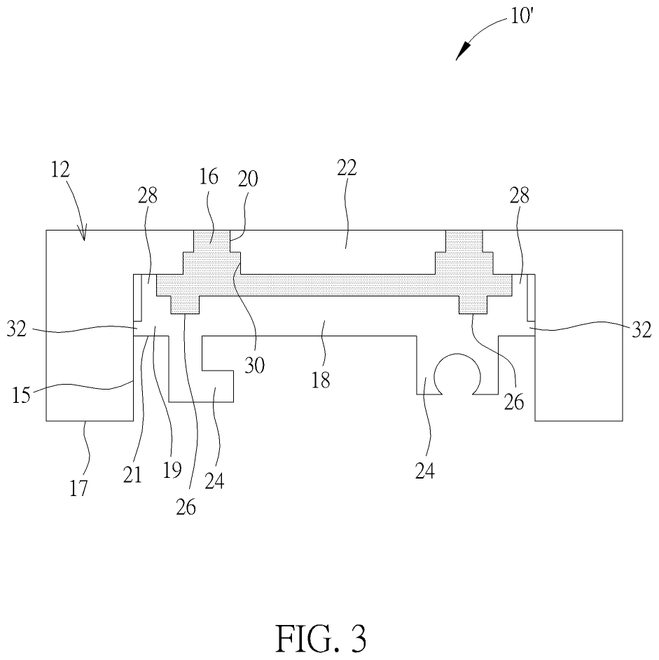

To be noted, the present invention could adopt an overflow prevention design. For example, please refer to FIG. 3, which is a cross-sectional diagram of a transparent keycap 10′ according to an embodiment of the present invention. Components both mentioned in FIG. 2 and FIG. 3 represent components with similar functions or structures, and the related description is omitted herein. As shown in FIG. 3, at least one flash groove 26 (two shown in FIG. 3, but not limited thereto) is formed on the transparent base 18. The flash groove 26 is communicated with the continuous hollow pattern region 20 for providing containing space to prevent overflowing of the transparent glue 16. At least one protruding structure 28 (two shown in FIG. 3, but not limited thereto) could be further formed on a skirt 19 of the transparent base 18 to abut against the opaque base 12 for preventing overflowing of the transparent glue 16 from the skirt 19 of the transparent base 18. Moreover, in this embodiment, a stepped structure 30 could be preferably formed at a periphery of the continuous hollow pattern region 20 to facilitate processing the transparent keycap 10′.

In addition, the present invention could adopt a base positioning design. As shown in FIG. 3, at least one positioning structure 32 (two shown in FIG. 3, but not limited thereto) is formed on the skirt 19 of the transparent base 18 to be engaged with a skirt 15 of the opaque base 12 (e.g., by structural interference or concave-convex engagement), so as to position the transparent base 18 under the opaque base 12 more steadily for efficiently improving the assembly quality of the transparent keycap 10′. Furthermore, as shown in FIG. 3, a bottom 21 of the skirt 19 of the transparent base 18 could be preferably higher than a bottom 17 of the skirt 15 of the opaque base 12, so as to make the transparent base 18 not exposed from the opaque base 12 for enhancing the whole appearance quality of the transparent keycap 10′.

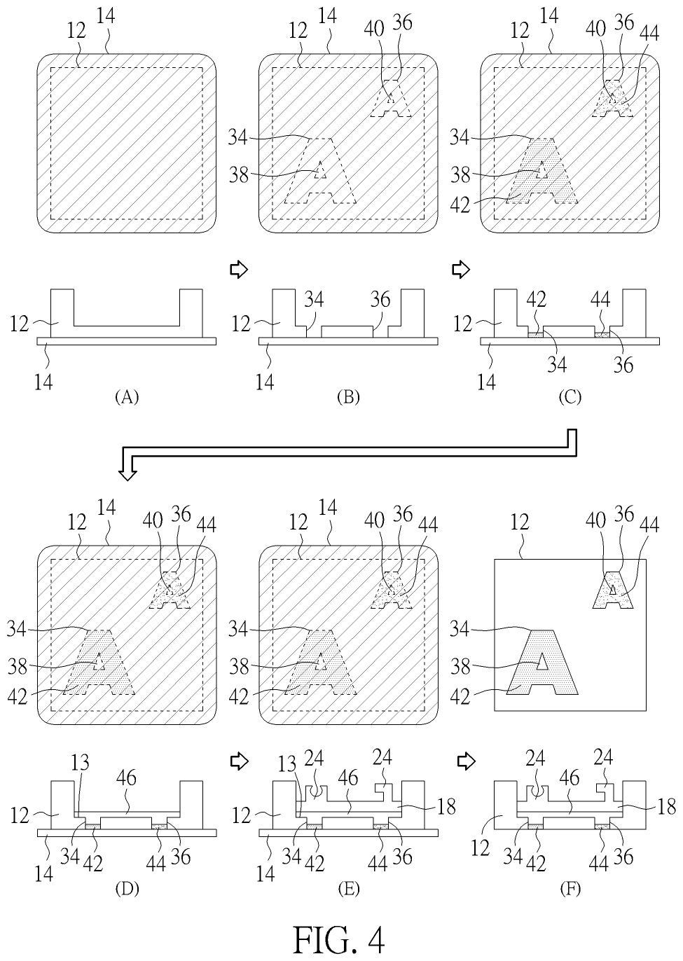

It should be mentioned that the pattern forming design of the keycap of the present invention is not limited to the aforesaid embodiment. Please refer to FIG. 4, which is a process diagram of a transparent keycap manufacturing method according to another embodiment of the present invention. For clear description of this embodiment, FIGS. 4(A)˜4(F) are presented by cross-sectional diagrams with top views. The major difference between this embodiment (as shown in FIG. 4) and the aforesaid embodiment (as shown in FIG. 2) is the transparent glue filling process. To be more specific, in this embodiment as shown in FIG. 4(F), the continuous hollow pattern region could include a first hollow pattern region 34 and a second hollow pattern region 36, the pattern component could include a first pattern 38 and a second pattern 40, and the transparent glue could include a first color glue 42, a second color glue 44, and an adhering glue 46, wherein the first pattern 38 is surrounded by the first hollow pattern region 34, the second pattern 40 is surrounded by the second hollow pattern region 36, and a color of the first color glue 42 is different from a color of the second color glue 44. During the transparent glue filling process, the first color glue 42 at least partially fill the first hollow pattern region 34 and the second color glue 44 at least partially fill the second hollow pattern region 36 (as shown in FIG. 4(C), but not limited thereto). Subsequently, the adhering glue 46 could be attached to the transparent base 18 and the bottom surface 13 of the opaque base and is connected to the first color glue 42 and the second color glue 44 as shown in FIGS. 4(D) and 4(E). In such a manner, a user can see different color light respectively emitted form the first hollow pattern region 34 and the second hollow pattern region 36 on the transparent keycap, so that the dual-color pattern lighting effect can be achieved. To be noted, the steps in FIG. 4 are substantially identical to the steps in FIG. 2, and because components both mentioned in FIG. 2 and FIG. 4 represent components with similar functions or structures, the related description is omitted herein.

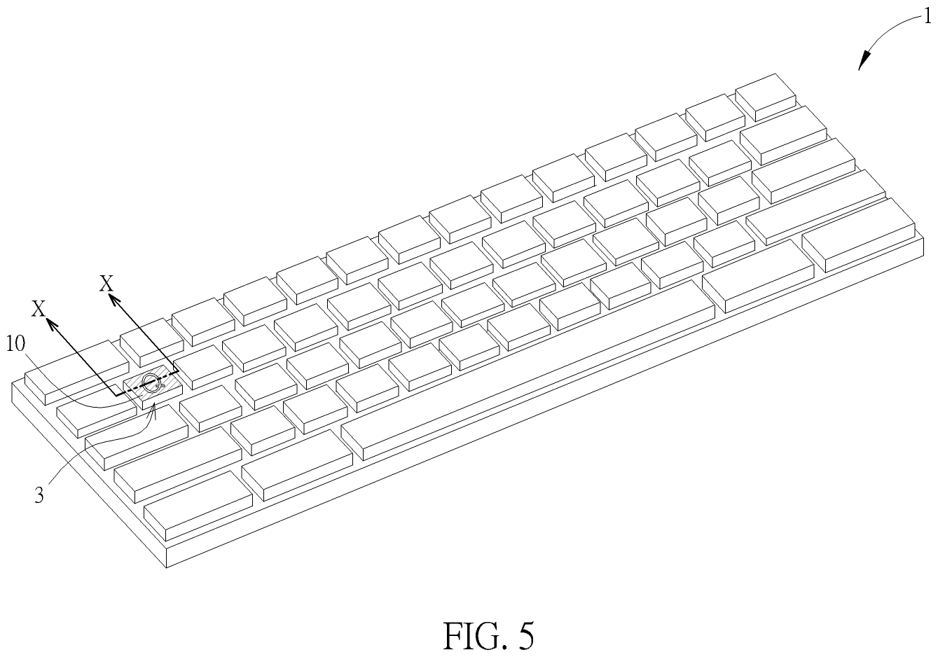

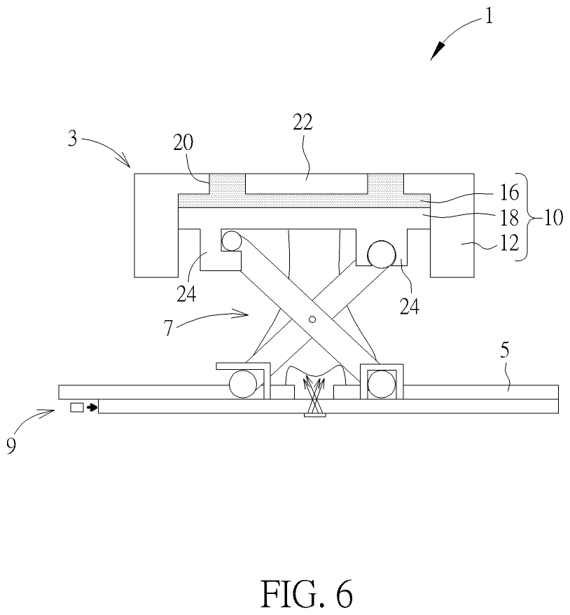

In practical application, please refer to FIG. 5 and FIG. 6. FIG. 5 is a diagram of a keyboard 1 according to an embodiment of the present invention. FIG. 6 is a cross-sectional diagram of a keyswitch 3 in FIG. 5 along a cross-sectional line X-X. As shown in FIG. 5 and FIG. 6, the keyboard 1 includes a plurality of keyswitches 3 and a board 5. The keyswitch 3 is disposed on the board 5 for a user to press, so as to perform a desired input function. To be more specific, the keyswitch 3 includes the transparent keycap 10, a scissor lifting mechanism 7 and a backlight module 9. The backlight module 9 is disposed under the board 5 for emitting light to the transparent keycap 10. The scissor lifting mechanism 7 is disposed between the transparent keycap 10 and the board 5 and is connected to the connection component 24 of the transparent keycap 10. Accordingly, when the transparent keycap 10 is pressed by the user, the transparent keycap 10 can move downward with the scissor lifting mechanism 7 to trigger a desired input function. Furthermore, when the backlight module 9 provides light, the light can be emitted out of the continuous hollow pattern region 20 after passing through the transparent base 18 and the transparent glue 16 sequentially, so as to make the transparent keycap 10 with a hard material luster provide the pattern lighting effect.

To be noted, the transparent keycap 10 can be manufactured by the method in FIG. 1 (but not limited thereto, meaning that the present invention could adopt the process as shown in FIG. 4 to generate the multicolor pattern lighting effect in another embodiment). In other words, the transparent keycap 10 can utilize the steps S10, S12, S14, S16 and S18 in FIG. 1 to perform the pattern forming process, and the related description is aforementioned and omitted herein.

In summary, the present invention adopts the design in which the fixing film is utilized to fix the pattern component in the continuous hollow pattern region and the transparent glue is utilized to fill the continuous hollow pattern region, to ensure that the pattern component can be fixed in the continuous hollow pattern region via the transparent glue after the fixing film is removed from the opaque base. Via the aforesaid design, even if the pattern component is completely cut off by the continuous hollow pattern region to be separate from the opaque base, the pattern component can be still fixed in the continuous hollow pattern region during the transparent keycap manufacturing process, so as to precisely form a whole pattern on the opaque base. In such a manner, the present invention can efficiently solve the prior art problem that non-transparent regions on the keycap needs to be connected to each other and cannot be completely cut off by the hollow pattern, so as to greatly improve the pattern design and manufacturing quality of the transparent keycap.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A transparent keycap manufacturing method comprising:
providing an opaque base and a fixing film;
adhering the opaque base to the fixing film;
performing a laser engraving process or an etching process on a bottom surface of the opaque base to generate a continuous hollow pattern region and a pattern component surrounded by the continuous hollow pattern region;
coating a transparent glue on the bottom surface of the opaque base to fill the continuous hollow pattern region with the transparent glue;
providing a transparent base having a plurality of connection components for connecting to a scissor lifting mechanism;
adhering a transparent base to the bottom surface of the opaque base; and
removing the fixing film from the opaque base.

2. The transparent keycap manufacturing method of claim 1, wherein the opaque base is made of metal or ceramic material.

3. The transparent keycap manufacturing method of claim 1, wherein the fixing film is a UV release film or a separate film.

4. The transparent keycap manufacturing method of claim 1, wherein the continuous hollow pattern region comprises a first hollow pattern region and a second hollow pattern region, the pattern component comprises a first pattern and a second pattern, the first hollow pattern region surrounds the first pattern, the second hollow pattern region surrounds the second pattern, the transparent glue comprises a first color glue, a second color glue and an adhering glue, the first color glue at least partially fills the first hollow pattern region, the second color glue at least partially fills the second hollow pattern region, the adhering glue is attached to the transparent base and the bottom surface of the opaque base and attached to the first color glue and the second color glue, and a color of the first color glue is different from a color of the second color glue.

5. The transparent keycap manufacturing method of claim 1 further comprising:
forming at least one flash groove on the transparent base, the at least one flash groove being communicated with the continuous hollow pattern region for preventing overflowing of the transparent glue.

6. The transparent keycap manufacturing method of claim 1 further comprising:
forming at least one protruding structure on a skirt of the transparent base to abut against the opaque base for preventing overflowing of the transparent glue from the skirt of the transparent base.

7. The transparent keycap manufacturing method of claim 1 further comprising:
forming at least one positioning structure on a skirt of the base to be engaged with a skirt of the opaque base for positioning the transparent base under the opaque base.

8. The transparent keycap manufacturing method of claim 1, wherein a bottom of a skirt of the transparent base is higher than a bottom of a skirt of the opaque base.

9. The transparent keycap manufacturing method of claim 1 further comprising:
forming a stepped structure at a periphery of the continuous hollow pattern region.

10. A transparent keycap comprising:
an opaque base having a fixing film attached thereon, a continuous hollow pattern region and a pattern component being formed on the opaque base by performing a laser engraving process or an etching process on a bottom surface of the opaque base, wherein the pattern component is surrounded by the continuous hollow pattern region;
a transparent glue coated on the bottom surface of the opaque base to fill the continuous hollow pattern region; and
a transparent base attached to the bottom surface of the opaque base, the transparent base having a plurality of connection components for connecting to a scissor lifting mechanism;
wherein the pattern component is fixed in the continuous hollow pattern region via the transparent glue after the fixing film is removed from the opaque base.

11. The transparent keycap of claim 10, wherein the opaque base is made of metal or ceramic material.

12. The transparent keycap of claim 10, wherein the fixing film is a UV release film or a separate film.

13. The transparent keycap of claim 10, wherein the continuous hollow pattern region comprises a first hollow pattern region and a second hollow pattern region, the pattern component comprises a first pattern and a second pattern, the first hollow pattern region surrounds the first pattern, the second hollow pattern region surrounds the second pattern, the transparent glue comprises a first color glue, a second color glue and an adhering glue, the first color glue at least partially fills the first hollow pattern region, the second color glue at least partially fills the second hollow pattern region, the adhering glue is attached to the transparent base and the bottom surface of the opaque base and attached to the first color glue and the second color glue, and a color of the first color glue is different from a color of the second color glue.

14. The transparent keycap of claim 10, wherein at least one flash groove is formed on the transparent base, and the at least one flash groove is communicated with the continuous hollow pattern region for preventing overflowing of the transparent glue.

15. The transparent keycap of claim 10, wherein at least one protruding structure is formed on a skirt of the transparent base to abut against the opaque base for preventing overflowing of the transparent glue from the skirt of the transparent base.

16. The transparent keycap of claim 10, wherein at least one positioning structure is formed on a skirt of the base to be engaged with a skirt of the opaque base for positioning the transparent base under the opaque base.

17. The transparent keycap of claim 10, wherein a bottom of a skirt of the transparent base is higher than a bottom of a skirt of the opaque base.

18. The transparent keycap of claim 10, wherein a stepped structure is formed at a periphery of the continuous hollow pattern region.
